(19) United States
(12) Patent Application Publication
(10) Pub. No.: US 2026/0303218 A1
(43) Pub. Date: Oct. 1, 2026

(54) DUAL-POLARIZATION BIDIRECTIONAL OPTICAL DEVICES

(71) Applicant: Aloe Semiconductor, Inc., Middletown, NJ (US)

(72) Inventor: Christopher R. Doerr, Middletown, NJ (US)

(21) Appl. No.: 19/634,959

(22) Filed: Mar. 31, 2026

Related U.S. Application Data
(60) Provisional application No. 63/780,925, filed on Mar. 31, 2025.

(51) Int. Cl. H04B 10/40; H04B 10/25; H04B 10/50; H04B 10/532; H04B 10/54; H04B 10/61; H04J 14/02; H04J 14/06

(52) U.S. Cl. CPC H04B 10/40; H04B 10/2589; H04B 10/505; H04B 10/532; H04B 10/54; H04B 10/614; H04J 14/0307; H04J 14/06

(57) ABSTRACT

An optical transceiver includes: a light source configured to output light having a first wavelength, a first modulator, a second modulator, a first photodetector, a second photodetector, a 2×2 multi-input-multi-output (MIMO) demultiplexer, a polarization beamsplitter, a first optical multiplexer/demultiplexer, wherein the first optical multiplexer/demultiplexer is wavelength selective between the first wavelength and a second wavelength different from the first wavelength, and a second optical multiplexer/demultiplexer, wherein the second optical multiplexer/demultiplexer is wavelength selective between the first wavelength and the second wavelength. The first modulator is connected between the light source and the first optical multiplexer/demultiplexer, the second modulator is connected between the light source and the second optical multiplexer/demultiplexer, the 2×2 MIMO demultiplexer is connected between the first and second optical multiplexer/demultiplexers and the first and second photodetectors, and the first and second optical multiplexer/demultiplexers are connected to the polarization beamsplitter.

### CROSS-REFERENCE TO RELATED APPLICATION

This application claims the benefit of priority to U.S. Provisional Patent Application No. 63/780,925, filed on Mar. 31, 2025, the entire contents of which are incorporated by reference herein.

### TECHNICAL FIELD

The present disclosure generally relates to multi-polarization optical devices and methods.

### BACKGROUND

In optical communication systems, multiplexing techniques (such as polarization-division multiplexing (PDM)) can increase communication capacity and/or photon efficiency by multiplexing different signals over different channels (e.g., different polarization modes) for simultaneous transmission through a single fiber. Bidirectional optical communication systems also increase fiber capacity by both sending and receiving signals.

### SUMMARY

Implementations of the present disclosure are generally directed to dual-polarization bidirectional optical transceivers.

In a first general aspect, an optical transceiver includes: a light source configured to output light having a first wavelength, a first modulator, a second modulator, a first photodetector, a second photodetector, a 2×2 multi-input-multi-output (MIMO) demultiplexer, a polarization beamsplitter, a first optical multiplexer/demultiplexer, wherein the first optical multiplexer/demultiplexer is wavelength selective between the first wavelength and a second wavelength different from the first wavelength, and a second optical multiplexer/demultiplexer, wherein the second optical multiplexer/demultiplexer is wavelength selective between the first wavelength and the second wavelength. The first modulator is connected between the light source and the first optical multiplexer/demultiplexer, the second modulator is connected between the light source and the second optical multiplexer/demultiplexer, the 2×2 MIMO demultiplexer is connected between the first and second optical multiplexer/demultiplexers and the first and second photodetectors, and the first and second optical multiplexer/demultiplexers are connected to the polarization beamsplitter.

Implementations of the first general aspect can have one or more of the following features.

In some implementations, the optical transceiver includes a splitter configured to split the light from the light source into a first input light and a second input light.

In some implementations, the first modulator is configured to modulate the first input light from the light source to output a first optical signal and the second modulator is configured to modulate the second input light from the light source to output a second optical signal.

In some implementations, the polarization beamsplitter includes a polarization beamsplitter rotator.

In some implementations, the polarization beamsplitter rotator is configured to: perform polarization rotation to cause a first modulated optical signal from the first optical multiplexer/demultiplexer and a second modulated optical signal from the second optical multiplexer/demultiplexer to have different polarizations, combine the first modulated optical signal and the second modulated optical signal into transmit light, provide the transmit light to a transmission link, and receive light from the transmission link.

In some implementations, the first optical multiplexer/demultiplexer includes: a first port configured to receive a first optical signal from the first modulator, a second port configured to provide an output as a first optical input to the 2×2 MIMO demultiplexer, and a third port configured to provide optical signals to a first port of the polarization beamsplitter and receive optical signals from the first port of the polarization beamsplitter. The first optical multiplexer/demultiplexer is configured to: combine optical signals from the first and second ports of the first optical multiplexer/demultiplexer to output a combined optical signal at the third port of the first optical multiplexer/demultiplexer, and wavelength-separate the optical signals received at the third port of the first optical multiplexer/demultiplexer into a first component, having the first wavelength, that is provided to the first port of the first optical multiplexer/demultiplexer, and a second component, having a second wavelength, that is provided to the second port of the first optical multiplexer/demultiplexer.

In some implementations, the first optical multiplexer/demultiplexer includes: a

Mach-Zehnder interferometer, a first 2×2 coupler connected between the first and second ports and two arms of the Mach-Zehnder interferometer, a second 2×2 coupler connected between the two arms of the Mach-Zehnder interferometer and a photodetector, and at least one phase-shifter on at least one of the two arms of the Mach-Zehnder interferometer, wherein the at least one phase-shifter is adjusted based on optical power detected by the photodetector.

In some implementations, the two arms of the Mach-Zehnder interferometer have different lengths.

In some implementations, the second 2×2 coupler is connected between the two arms of the Mach-Zehnder interferometer and a port of the first optical multiplexer/demultiplexer that is connected to the polarization beamsplitter.

In some implementations, the optical transceiver includes a transimpedance amplifier configured to receive and amplify a first electrical signal from the first photodetector.

In some implementations, the optical transceiver includes an electrical 2×2 MIMO demultiplexer configured to perform 2×2 MIMO demultiplexing on electrical signals received from the first and second photodetectors.

In some implementations, the first general aspect includes a second light source, a third modulator, a fourth modulator, a third photodetector, a fourth photodetector, a second 2×2 MIMO demultiplexer configured to provide two outputs to the third photodetector and the fourth photodetector, respectively, a second polarization beamsplitter, a third optical multiplexer/demultiplexer, wherein the third optical multiplexer/demultiplexer is wavelength selective, and a fourth optical multiplexer/demultiplexer, wherein the fourth optical multiplexer/demultiplexer is wavelength selective. The third modulator is connected between the second light source and the third optical multiplexer/demultiplexer, the fourth modulator is connected between the second light source and the fourth optical multiplexer/demultiplexer, the second 2×2 MIMO demultiplexer is connected between the third and fourth optical multiplexer/demultiplexers and the third and fourth photodetectors, and the third and fourth optical multiplexer/demultiplexers are connected to the second polarization beamsplitter.

In some implementations, the optical transceiver is integrated on a single chip.

In some implementations, the optical transceiver includes a silicon photonics chip.

In some implementations, an optical transceiver includes: a light source configured to output light having a first wavelength, a splitter configured to split the light from the light source into a first input light and a second input light, a first modulator configured to modulate the first input light from the light source to output a first optical signal, a second modulator configured to modulate the second input light from the light source to output a second optical signal, a first photodetector configured to receive light at a second wavelength different from the first wavelength, a second photodetector configured to detect light at the second wavelength, a polarization demultiplexer configured to receive two optical inputs and provide two polarization-demultiplexed outputs to the first photodetector and the second photodetector, respectively, a polarization beamsplitter, a first optical element, and a second optical element. The first optical element can include: a first port configured to receive the first optical signal, a second port configured to provide an output as a first optical input to the polarization demultiplexer, and a third port configured to provide optical signals to a first port of the polarization beamsplitter and receive optical signals from the first port of the polarization beamsplitter. The first optical element can be configured to: combine optical signals from the first and second ports of the first optical element to output a combined optical signal at the third port of the first optical element, and wavelength-separate the optical signals received at the third port of the first optical element into a first component, having the first wavelength, that is provided to the first port of the first optical element, and a second component, having the second wavelength, that is provided to the second port of the first optical element. The second optical element can include a first port configured to receive the second optical signal, a second port configured to provide an output as a second optical input to the polarization demultiplexer, and a third port configured to provide optical signals to a second port of the polarization beamsplitter and receive optical signals from the second port of the polarization beamsplitter. The second optical element can be configured to: combine optical signals from the first and second ports of the second optical element to output a combined optical signal at the third port of the second optical element, and wavelength-separate the optical signals received at the third port of the second optical element into a first component, having the first wavelength, that is provided to the first port of the second optical element, and a second component, having the second wavelength, that is provided to the second port of the second optical element.

In a second general aspect, sending and receiving dual-polarization signals includes: splitting light having a first wavelength into a first input light and a second input light, modulating the first input light to yield a first optical signal and modulating the second input light to yield a second optical signal, receiving and providing the first optical signal to a first optical element to yield an output as a first input to a 2×2 MIMO demultiplexer, receiving and providing the second optical signal to a second optical element to yield an output as a second input to the 2×2 MIMO demultiplexer, performing 2×2 MIMO demultiplexing on the first input to generate a first 2×2 MIMO demultiplexed output to a first photodetector, and performing 2×2 MIMO demultiplexing on the second input to generate a second 2×2 MIMO demultiplexed output to a second photodetector.

Implementations of the second general aspect can include one or more of the following features.

In some implementations, the first and second optical elements include wavelength selective optical elements.

In some implementations, receiving and providing the first optical signal to the first optical element to yield the output as the first input includes: receiving and providing the first optical signal from a first modulator to the first optical element through a first port of the first optical element, receiving and providing the first optical signal from the first optical element to a polarization beamsplitter rotator through a second port of the first optical element, and receiving and providing the first optical signal from the polarization beamsplitter rotator to a 2×2 MIMO demultiplexer through a third port of the first optical element.

In some implementations, receiving and providing the second optical signal to the second optical element to yield the output as the second input includes: receiving and providing the second optical signal from a second modulator to the second optical element through a first port of the second optical element, receiving and providing the second optical signal from the second optical element to a polarization beamsplitter rotator through a second port of the second optical element, and receiving and providing the second optical signal from the polarization beamsplitter rotator to a 2×2 MIMO demultiplexer through a third port of the second optical element.

In a third general aspect, an optical transceiver includes: a light source configured to output light having a first wavelength, a transmission unit configured to output a first modulated input signal and a second modulated input signal, a polarization beamsplitter rotator configured to cause the first modulated input signal and the second modulated input signal to have different polarizations, a first optical element configured to (i) receive the first modulated input signal from the transmission unit, (ii) provide and receive optical signals to and from the polarization beamsplitter rotator, and (iii) provide a first optical signal from the polarization beamsplitter rotator to a receiving unit, wherein the first optical element is wavelength selective, a second optical element configured to (i) receive the second modulated input signal from the transmission unit, (ii) provide and receive optical signals to and from the polarization beamsplitter rotator, and (iii) provide a second optical signal from the polarization beamsplitter rotator to the receiving unit, wherein the second optical element is wavelength selective, and the receiving unit. The receiving unit is configured to (i) receive the first optical signal and the second optical signal, (ii) perform polarization-demultiplexing on the first optical signal and the second optical signal to output two polarization-demultiplexed optical signals, and (iii) detect intensities of the two polarization-demultiplexed optical signals.

Implementations of the third general aspect can include one or more of the following features.

In some implementations, the optical transceiver is integrated on a single chip.

In some implementations, the first and second optical elements include: a Mach-Zehnder interferometer, a first 2×2 coupler connected between the transmission unit and two arms of the Mach-Zehnder interferometer, a second 2×2 coupler connected between the two arms of the Mach-Zehnder interferometer and a photodetector, and at least one phase-shifter on at least one of the two arms of the Mach-Zehnder interferometer, wherein the at least one phase-shifter is adjusted based on optical power detected by the photodetector.

In a fourth general aspect, an optical transceiver includes: an input/output port, wherein the optical transceiver is configured to transmit a first dual-polarization optical signal having a first wavelength at the input/output port, and wherein the optical transceiver is configured to receive a second dual-polarization optical signal having a second wavelength at the input/output port, wherein the first wavelength is different from the second wavelength.

Implementations of the fourth general aspect can include one or more of the following features.

In some implementations, the fourth general aspect includes a transmission unit configured to output a first modulated input signal and a second modulated input signal carrying first data and second data, respectively, wherein the first modulated input signal and the second modulated input signal have the first wavelength, and wherein the first dual-polarization optical signal is based on the first modulated input signal and the second modulated input signal, and a receiving unit configured to receive a first optical signal and a second optical signal and detect a first data signal and a second data signal based on 2×2 MIMO demultiplexing, wherein the first optical signal and the second optical signal have the second wavelength, and wherein the first optical signal and the second optical signal are based on the second dual-polarization optical signal.

In some implementations, the fourth general aspect includes a wavelength-selective multiplexer/demultiplexer configured to operate on light from the first dual-polarization optical signal and on light from the second dual-polarization optical signal.

In some implementations, the first dual-polarization optical signal and the second dual-polarization optical signal are dual-polarization intensity-modulated direct-detect signals.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 illustrates an example of an optical transceiver.

FIG. 2A illustrates an example of an optical transceiver.

FIG. 2B illustrates an example of optical transceivers.

FIG. 3 illustrates an example of an optical element.

FIG. 4 is a flow chart showing example operations of sending and receiving dual-polarization signals.

### DETAILED DESCRIPTION

This disclosure describes dual-polarization optical devices and methods, including dual-polarization bidirectional optical devices and methods. Bidirectional optical devices are configured to send and receive optical signals (e.g., simultaneously) in both directions over a single wave guide or fiber. High escape and cabling density are becoming more important, especially for artificial intelligence applications. Optical circuit switching (OCS), which can reduce cost and power, benefits from reducing the number of interconnect fibers. In a dual-polarization communication system, two signals are multiplexed and transmitted using the two different polarization modes of light, thereby doubling the data capacity for a given number of interconnect fibers. The receiver performs polarization demultiplexing to separate the two signals in the two polarization modes, thereby recovering the data transmitted in each of the two signals. Dual-polarization (DP) and bidirectional (BiDi) systems can provide improved density (e.g., provide a factor of two each increase in optical interconnect density). BiDi systems generally can be categorized as a two-wavelength BiDi system or a one-wavelength BiDi system. A two-wavelength BiDi system utilizes different wavelengths for transmissions in different directions on the same fiber, to avoid in-band interference between channels due at least in part to reflections. A one-wavelength BiDi system utilizes the same wavelength for transmissions in both directions. Some implementations of this disclosure provide two-wavelength BiDi systems.

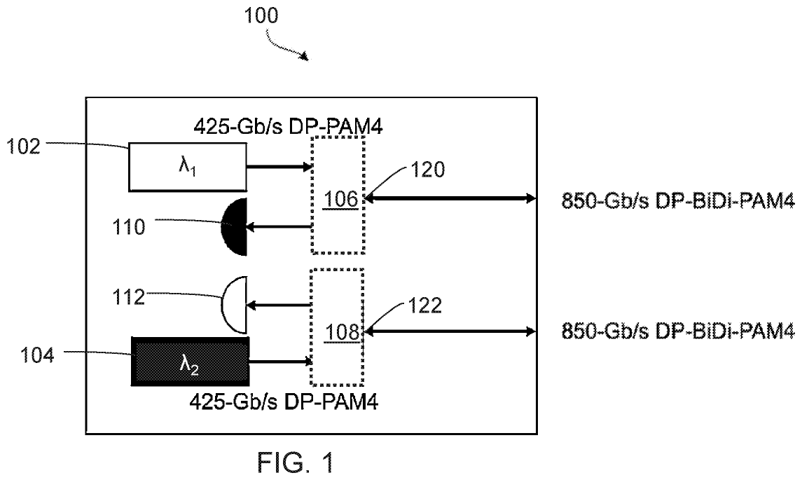

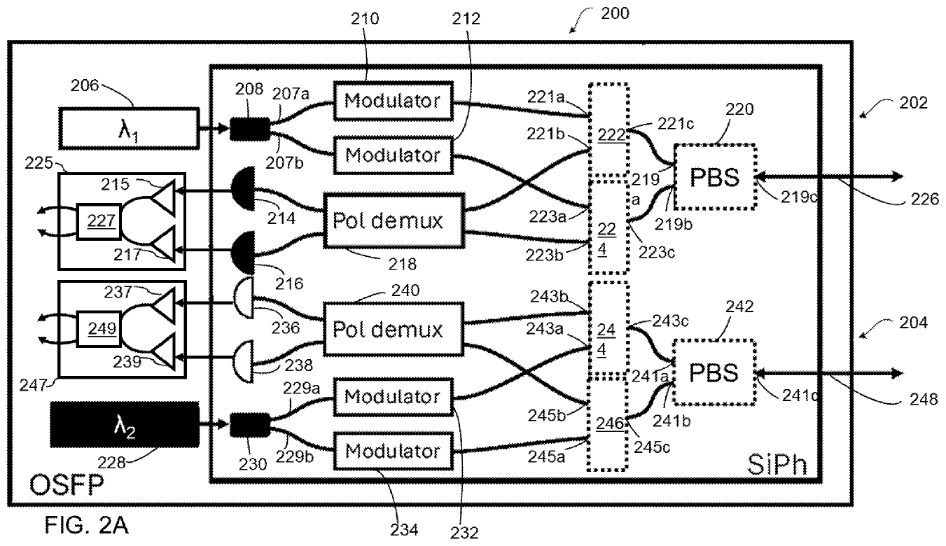

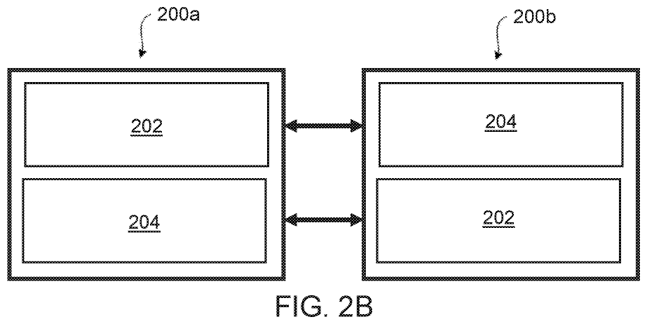

FIG. 1 illustrates an example of an optical system 100. FIG. 1 provides a schematic representation of a dual-polarization-bidirectional (BiDi) optical system; an example of such a system is shown in more detail in FIG. 2A. In some cases, the optical system is integrated on a single chip.

In the optical system 100, optical sources 102, 104 are configured to output having two different wavelengths λ₁, λ₂. The light (e.g., laser light) is processed using dual-polarization multiplexing and demultiplexing in a bidirectional manner, such that the optical system 100 can both send and receive signals. The system can perform wavelength multiplexing/demultiplexing using optical units 106, 108. The use of dashed lines in FIG. 1 indicates that the element is configured to handle different wavelengths. For example, the optical units 106, 108, are configured to handle two different wavelengths λ₁, λ₂. The use of black fill indicates that an element (e.g., optical source 104 and first detection unit 110) is configured to handle (e.g., emit or detect) a second wavelength λ₂. The use of a normal outline with no fill indicates that an element (e.g., optical source 102 and second detection unit 112) is configured to handle (e.g., emit or detect) a first wavelength λ₁. “Handle” can refer to a sensitivity of a photodetector. For example, a photodetector configured to handle λ₁ may-though need not—have a higher sensitivity to light having wavelength λ₁ than to light having wavelength λ_{2.} In some implementations, “handle” refers to an effectiveness of an optical element. For example, a modulator or polarization demultiplexer configured to handle λ₁ may-though need not—exhibit higher loss for light having wavelength λ₂ than for light having wavelength λ₁, and/or may—though need not—more effectively modulate or polarization-demultiplex light having wavelength λ₁ than light having wavelength λ₂.

The optical units 106, 108 can be configured to perform splitting, modulation, wavelength separation/combining, polarization multiplexing/demultiplexing, and/or polarization rotation/combining/splitting. As a result, the optical system 100 is configured to output, at a first input/output port 120, dual-polarization signals having the first wavelength and, at a second input/output port 122, output dual-polarization signals having the second wavelength. A dual-polarization signal can carry two independent data signals on respective different polarizations of light. The optical system 100 is also configured to receive, at the first input/output port 120, input dual-polarization signals having the second wavelength, which are received by a first detection unit 110. For example, the first detection unit 110 can represent two photodetectors configured to receive respective polarizations of light from the input dual-polarization signals received at the first input/output port 120. Similarly, the optical system 100 is configured to receive, at the second input/output port 122, input dual-polarization signals having the first wavelength, which are received by a second detection unit 112. For example, the second detection unit 112 can represent two photodetectors configured to receive respective polarizations of light from the input dual-polarization signals received at the second input/output port 122. As a result, the optical system 100 can provide dual-wavelength, dual-polarization transmission and reception of light, providing a factor of four increase in fiber capacity, e.g., for short links.

For example, the optical system 100 can be configured for 425 Gb/s per fiber pair using dual-polarization (DP)-Pulse Amplitude Modulation 4-level (PAM4) with a tracking speed sufficient for robust fiber handling. As another example, the optical system 100 can be configured for 850 Gb/s per fiber pair using DP-bidirectional (BiDi)-PAM4. Other modulation schemes are also within the scope of this disclosure; the optical units 106, 108 can include modulators configured to provide the modulation.

FIG. 2A illustrates an example of an optical transceiver 200 according to some implementations of the present disclosure (e.g., an example of the system of FIG. 1). The optical transceiver 200 includes a first optical transceiver 202 (components in the top half of the optical transceiver 200 as shown in FIG. 2A) and a second optical transceiver 204 (components in the bottom half of the optical transceiver 200 as shown in FIG. 2A). In some implementations, the first optical transceiver 202 and the second optical transceiver 204 are arranged on a common chip.

The first optical transceiver 202 includes a light source 206, a splitter 208, a first modulator 210, a second modulator 212, a first photodetector 214, a second photodetector 216, a polarization demultiplexer 218, a polarization beamsplitter rotator 220, a first optical element 222, and a second optical element 224. The polarization beamsplitter rotator 220 is configured to provide and/or receive signals from a transmission link 226 (e.g., through a port connected to the transmission link 226). In some implementations, the transmission link 226 is an optical fiber.

In FIG. 2A, the use of dashed lines indicates that the element is configured to handle different wavelengths. For example, the optical elements 222, 224, are configured to handle two different wavelengths λ₁, λ₂. The use of black fill indicates that a light source or photodetector (e.g., second light source 228 and photodetectors 214, 216) is configured to handle (e.g., emit or detect) a second wavelength λ₂. The use of a normal outline with no fill indicates that a light source or photodetector (e.g., light source 206 and photodetectors 236, 238) is configured to handle (e.g., emit or detect) a first wavelength λ₁. Other elements, such as the splitters 208, 230, modulators 210, 212, 232, 234, and polarization demultiplexers 218, 240 can be configured to handle both wavelengths λ₁, λ₂ and/or can be configured to handle just one of the wavelengths λ₁, λ₂. For example, in some implementations, at least one of splitter 208, polarization demultiplexer 240, or modulators 210, 212 is configured to handle λ₁ (e.g., in comparison to λ₂), and/or at least one of splitter 230, polarization demultiplexer 218, or modulators 232, 234 is configured to handle λ₂ (e.g., in comparison to λ₁).

The light source 206 is configured to output light having a first wavelength. In some implementations, the first wavelength is 1271 nm, but other wavelengths are also within the scope of this disclosure. The splitter 208 is configured to split the light from the light source 206 into a first input light and a second input light provided into a first optical transmission path 207a and a second optical transmission path 207b, respectively. The light source 206 can be any suitable type of light source, for example, a laser. Modulators are used to encode and embed data in output signals (light, such as laser light), e.g., as split by the illustrated splitter 208. In some implementations, the modulators are amplitude modulators. The first modulator 210 is configured to modulate the first input light from the light source 206 to output a first optical signal, e.g., carrying first data. In some implementations, the first modulator 210 is an amplitude modulator. The second modulator 212 is configured to modulate the second input light from the light source 206 to output a second optical signal, e.g., carrying second data. In some implementations, the second modulator 212 is an amplitude modulator. The modulators 210, 212 can be configured to modulate the first and second input light according to any suitable modulation scheme, e.g., PAM4, binary modulation (e.g., PAM2), or higher-order approaches (e.g., PAM8, PAM16, etc.). The modulators 210, 212 can be, for example, Mach-Zehnder modulators, but are not limited thereto.

The first optical signal is provided into a first port 221a of the first optical element 222, and the second optical signal is provided into a first port 223a of the second optical element 224. The first and second optical elements 222, 224 can each be a wavelength-selective multiplexer/demultiplexer (e.g., a wavelength-selective 2×1 mux/demux), or a wavelength separator/combiner.

For example, the first optical element 222 includes the first port 221a configured to receive the first optical signal from the first modulator 210, a second port 221b configured to provide an output as a first optical input to the polarization demultiplexer 218, and a third port 221c configured to provide optical signals to the polarization beamsplitter rotator 220 and receive optical signals from the polarization beamsplitter rotator 220. The first port 221a is connected to the first modulator 210, the second port 221b is connected to the polarization demultiplexer 218, and the third port 221c is connected to the polarization beamsplitter rotator 220.

The first optical element 222 is configured to combine optical signals from the first and second ports 221a and 221b of the first optical element 222 to output a combined optical signal at the third port 221c of the first optical element 222. For example, the combined optical signal can be provided to the polarization beamsplitter rotator 220. The first optical element 222 is configured to wavelength-separate (or wavelength-selectively split) optical signals received at the third port 221c of the first optical element 222 into a first component having the first wavelength and a second component having a second wavelength different from the first wavelength. The first component is provided to the first port 221a of the first optical element 222 and the second component is provided to the second port 221b of the first optical element 222 (e.g., is provided to the polarization demultiplexer 218).

The second optical element 224 includes a first port 223a configured to receive the second optical signal from the second modulator 212, a second port 223b configured to provide an output as a second optical input to the polarization demultiplexer 218, and a third port 223c configured to provide optical signals to a second optical port 219b of the polarization beamsplitter rotator 220 and receive optical signals from the second optical port of the polarization beamsplitter rotator 220. The second optical element 224 is configured to combine optical signals from the first and second ports 223a and 223b of the second optical element 224 to output a combined optical signal at the third port 223c of the second optical element 224. The second optical element 224 is configured to wavelength-separate the optical signals received at the third port of the second optical element 224 into a first component having the first wavelength and a second component having the second wavelength. The first component is provided to the first port 223a of the second optical element 224 and the second component is provided to the second port 223b of the second optical element 224 (e.g., is provided to the polarization demultiplexer 218).

A polarization beamsplitter or a polarization beamsplitter rotator can be used for both transmission and reception of optical signals. As a result of operation of the first optical element 222, the first optical signal (e.g., light having the first wavelength and modulated by modulator 210, sometimes referred to as “first modulated input light”) is provided into a first port 219a of the polarization beamsplitter rotator 220. Contributions of light into the first port 219a of the polarization beamsplitter rotator 220 from the second port 221b of the first optical element 222 may be very limited, or essentially none, because the second port 221b of the first optical element 222 is not connected to optical sources. As a result of operation of the second optical element 224, the second optical signal (e.g., light having the first wavelength and modulated by modulator 212, sometimes referred to as “second modulated input light”) is provided into a second port 219b of the polarization beamsplitter rotator 220, with similarly little or no light from the second port of the second optical element 224.

In some implementations, a transmission unit is configured to output the first modulated input signal and the second modulated input signal. For example, a transmission unit can include the splitter 208, the first modulator 210, and the second modulator 212.

The polarization beamsplitter rotator 220 is configured to rotate the first modulated input light and/or the second modulated input light to have different polarizations, combine the first modulated input light and the second modulated input light into transmit light, and provide the transmit light into the transmission link 226 through third port 219c of the polarization beamsplitter rotator 220. For example, the polarization beamsplitter rotator 220 can be configured to rotate the polarization of one of the first modulated input light or the second modulated input light by 90°, such that, in the transmit light, the first modulated input light and the second modulated input light have orthogonal polarizations. Thus, the first optical transceiver 202 provides dual-polarization transmission.

Although described as a polarization beamsplitter rotator 220, in some implementations the optical element 220 can be a polarization beamsplitter (PBS), e.g., without necessarily including a rotation functionality. For example, polarization rotation to provide dual-polarization signals for transmission (and, optionally, to rotate components of received signals for compatibility with optical elements) can be performed by one or more polarization-modifying (e.g., rotating) optical elements distinct from the optical element 220.

In addition to dual-polarization transmission, the first optical transceiver 202 performs dual-polarization reception, such that the first optical transceiver 202 can be configured as a DP-BiDi transceiver. A received optical signal having the second wavelength can be received through the transmission link 226 at the third port 219c of the polarization beamsplitter rotator 220. The second wavelength can be, for example, 1310 nm, but is not limited thereto. The third port 219c of the polarization beamsplitter rotator 220 can be configured to split the received optical signal into components having different (e.g., orthogonal) polarizations. For example, the received optical signal can be based on a first modulated received signal having a first polarization and a second modulated received signal having a second, different polarization. The first and second modulated received signals can carry respective different data, e.g., based on their modulation (which can be any of the modulation types discussed with respect to the modulators 210, 212). However, the two polarization modes may become mixed among each other due to unpredictable rotations and cross-talk, e.g., in the transmission link 226. Therefore, the received optical signal can include a first received signal and a second received signal having the first and second polarization, respectively, where the first and second received signals are each a mixture of the first modulated received signal and the second modulated received signal.

The polarization beamsplitter rotator 220 can be configured to provide the first received signal into the third port 221c of the first optical element 222, and to provide the second received signal into the third port 223c of the second optical element 224, e.g., by performing polarization-based separation. In some implementations, the polarization beamsplitter rotator 220 can rotate one or both of the first and second received signals to cause the first and second received signals, as provided into the first and second optical elements 222, 224, respectively, to have the same polarization.

The first optical element 222 performs wavelength-selective demultiplexing/wavelength separation and provides the first received signal to the polarization demultiplexer 218 through the second port 221b of the first optical element 222, based on the first received signal having the second wavelength. Similarly, the second optical element 224 performs wavelength-selective demultiplexing/wavelength separation and provides the second received signal to the polarization demultiplexer 218 through the second port 223b of the second optical element 224, based on the second received signal having the second wavelength.

The polarization demultiplexer 218 can be a 2×2 multi-input-multi-output (MIMO) demultiplexer. The polarization demultiplexer 218 can be configured to operate on the first and second received signals to recover and separately provide, through two respective outputs, the first modulated received signal and the second modulated received signal. Examples of suitable demultiplexers are described in US Patent Publication No. 2025/0247164, the entirety of which is incorporated herein by reference. It will be understood, however, that any suitable demultiplexer can be used. It will be understood that a “polarization demultiplexer,” as referred to herein, need not incorporate polarization-related elements but, rather, can be any suitable MIMO demultiplexer (e.g., a 2×2 MIMO demultiplexer). In combination with operation of the PBS 220, such a multiplexer can act as a polarization demultiplexer, but independently may, for example, demultiplex a mix of signals (e.g., orthogonal signals) without requiring reference to polarization.

Based on operation of the polarization demultiplexer 218, the first photodetector 214 receives the first modulated received signal (carrying third data) and the second photodetector 216 receives the second modulated received signal (carrying fourth data). The photodetectors 214, 216 can output respective electrical signals indicative of the third data and fourth data, respectively. The photodetectors 214, 216 can detect intensities of received light.

Although described as an amplitude modulator, in some cases, the modulators (e.g., modulators 210, 212) are phase modulators (e.g., differential phase shift keying (DPSK) modulators or differential quadrature phase shift keying (DQPSK) modulators). In such implementations, an optical transceiver such as the first optical transceiver 202 of FIG. 2A performs similar operations but includes DPSK demodulators. For example, DPSK demodulators (not shown) can be connected between the polarization demultiplexer 218 and the photodetectors 214, 216 to convert phase differences of received differentially-encoded signals into optical intensity variations. Based on operation of the polarization demultiplexer 218 and the optical demodulators, the first photodetector 214 receives the first modulated received signal (carrying third data) and the second photodetector 216 receives the second modulated received signal (carrying fourth data). The photodetectors 214,216 can output respective electrical signals indicative of the third data and the fourth data, respectively.

In some implementations, a receiving unit is configured to receive the first optical signal and the second optical signal, perform polarization-demultiplexing on the first optical signal and the second optical signal to output two polarization-demultiplexed optical signals, and detect intensities of the two polarization-demultiplexed optical signals. For example, a receiving unit can include the polarization demultiplexer 218, the first photodetector 214, and the second photodetector 216.

In some implementations, the electrical signals output by the photodetectors 214, 216 can be further processed. For example, the first optical transceiver 202 can include an electrical demultiplexer configured to receive the electrical signals and perform further demultiplexing to recover the third data and the fourth data with less loss. In some implementations, the first optical transceiver 202 includes transimpedance amplifiers (TIA) configured to amplify the electrical signals.

In some implementations, the first optical transceiver 202 includes an electrical module 225. The electrical signals from the photodetectors 214, 216 are optionally provided into the electrical module 225 including a first transimpedance amplifier 215 and a second transimpedance amplifier 217 that produce amplified versions of the signals from the photodetectors. The electrical module 225 may contain an electrical demultiplexer 227. The electrical demultiplexer is configured to assist with performing demultiplexing on electrical signals received from the first and second photodetectors 214, 216, e.g., to assist in recovering the third data and the fourth data. The polarization demultiplexer 218 performs the primary demultiplexing, at least in part because photodetectors 214 and 216 perform square-law detection. In some implementations, a receiving unit can include the polarization demultiplexer 218, the first photodetector 214, the second photodetector 216, and the electrical module 225.

As a result of the operation described above, the first optical transceiver 202 is configured to transmit dual-polarization signals at the first wavelength and to receive dual-polarization signals at the second wavelength, advantageously providing DP-BiDi functionality.

Further, some configurations of the first optical transceiver 202 can provide specific advantages beyond the DP-BiDi functionality. First, the first and second optical elements 222, 224 (e.g., wavelength-selective multiplexers/demultiplexers) can be configured to operate on both transmitted (outbound) signals and received (inbound) signals, thereby providing dual, combined functionality that makes efficient use of components and space (e.g., in the context of a SiPh configuration). Similarly, the polarization beamsplitter rotator 220 is also used for both transmission and reception. Thus, the configuration shown in FIG. 2A can provide a lower cost and/or improved spatial efficiency compared to configurations that have less use of the same component(s) for both transmission and reception.

Further, the configuration shown in FIG. 2A can exhibit reduced loss and/or improved signal processing quality. For example, the first optical transceiver 202 can exhibit high resilience to crosstalk and leakage between signals of the first and second wavelength. For example, even if a signal received through the transmission link 226 includes components having the first wavelength, those components are substantially or entirely separated by the first and second optical elements 222, 224 and are provided to the modulators 210, 212 (e.g., rather than being photodetected), where the components have little or no effect on operation of the first optical transceiver 202.

The optical transceiver 200 can further include the second optical transceiver 204. It will be understood that the second optical transceiver 204 is not required and can be omitted or altered without departing from the scope of this disclosure. As shown in FIG. 2A, the second optical transceiver 204 is configured similarly to the first optical transceiver 202, but the second optical transceiver 204 is configured to transmit at the second wavelength and receive at the first wavelength.

The second optical transceiver 204 includes a second light source 228, a second splitter 230, a third modulator 232, a fourth modulator 234, a third photodetector 236, a fourth photodetector 238, a second polarization demultiplexer 240, a second polarization beamsplitter rotator 242, a third optical element 244, and a fourth optical element 246. The second polarization beamsplitter rotator 242 is configured to provide and/or receive signals from a second transmission link 248 (e.g., through a port connective to the second transmission link 248). In some implementations, the second transmission link 248 is an optical fiber.

The second light source 228 is configured to output a second light having the second wavelength. In some implementations, the second wavelength is 1310 nm, but other wavelengths are also within the scope of this disclosure. The second light source 228 can be any suitable type of light source, for example, a laser. The second splitter 230 is configured to split the second light from the second light source 228 into a third input light and a fourth input light and provide into a third optical transmission path 229a and a fourth optical transmission path 229b, respectively.

The third modulator 232 is configured to modulate the third input light from the second light source 228 to output a third optical signal, e.g., carrying fifth data. In some implementations, the third modulator 232 is an amplitude modulator. The fourth modulator 234 is configured to modulate the fourth input light from the second light source 228 to output a fourth optical signal, e.g. carrying sixth data. In some implementations, the fourth modulator 234 is an amplitude modulator. The modulators 232, 234 can be configured to modulate the third and fourth input light according to any suitable modulation scheme, e.g., PAM4, binary modulation (e.g., PAM2), or higher-order approaches (e.g., PAM8, PAM16, etc.). The modulators 232, 234 can be, for example, Mach-Zehnder modulators, but are not limited thereto.

The third optical element 244 is configured similarly to the first optical element 222 (e.g., the third optical element 244 includes a first port 243a configured to receive the third optical signal from the third modulator 232, a second port 243b configured to provide an output as a third optical input to the second polarization demultiplexer 240, and a third port 243c configured to provide optical signals to the second polarization beamsplitter rotator 242 and receive optical signals from the second polarization beamsplitter rotator 242). The fourth optical element 246 is configured similarly to the second optical element 224 (e.g., the second optical element includes a first port 245a configured to receive the fourth optical signal from the fourth modulator 234, a second port 245b configured to provide an output as a fourth optical input to the second polarization demultiplexer 240, and a third port 245c configured to provide optical signals to the second polarization beamsplitter rotator 242 and receive optical signals from the second polarization beamsplitter rotator 242).

The third optical element 244 is configured to combine optical signals from the first and second ports 243a and 243b of the third optical element 244 to output a combined optical signal at the third port 243c of the third optical element 244. For example, the combined optical signal can be provided to the second polarization beamsplitter rotator 242. The third optical element 244 is configured to wavelength-separate (or wavelength-selectively split) optical signals received at the third port 243c of the third optical element 244 into a third component having the second wavelength and a fourth component having the first wavelength different from the second wavelength. The third component is provided to the first port 243a of the third optical element 244 and the fourth component is provided to the second port 243b of the third optical element 244 (e.g., is provided to the second polarization demultiplexer 240).

The fourth optical element 246 includes a first port 245a configured to receive the fourth optical signal from the fourth modulator 234, a second port 245b configured to provide an output as a fourth optical input to the second polarization demultiplexer 240, and a third port 245c configured to provide optical signals to a second optical port 241b of the second polarization beamsplitter rotator 242 and receive optical signals from the second optical port 241b of the second polarization beamsplitter rotator 242. The fourth optical element 246 is configured to combine optical signals from the first and second ports 245a and 245b of the fourth optical element 246 to output a combined optical signal at the third port 245c of the fourth optical element 246. The fourth optical element 246 is configured to wavelength-separate the optical signals received at the third port 245c of the fourth optical element 246 into a third component having the second wavelength and a fourth component having the first wavelength. The third component is provided to the first port 245a of the fourth optical element 246 and the fourth component is provided to the second port 245b of the fourth optical element 246 (e.g., is provided to the second polarization demultiplexer 240).

A polarization beamsplitter or a polarization beamsplitter rotator can be used for both transmission and reception of optical signals. As a result of operation of the third optical element 244, the third optical signal (e.g., light having the second wavelength and modulated by the third modulator 232, sometimes referred to as “third modulated input light”) is provided into a first port 241a of the second polarization beamsplitter rotator 242. Contributions of light into the first port 241a of the second polarization beamsplitter rotator 242 from the second port 243b of the third optical element 244 may be very limited, or essentially none, because the second port 243b of the third optical element 244 is not connected to optical sources. As a result of operation of the fourth optical element 246, the fourth optical signal (e.g., light having the second wavelength and modulated by fourth modulator 234, sometimes referred to as “fourth modulated input light”) is provided into a second port 241b of the second polarization beamsplitter rotator 242, with similarly little or no light from the second port 245b of the fourth optical element 246.

In some implementations, a transmission unit is configured to output the third modulated input signal and the fourth modulated input signal. For example, a transmission unit can include the second splitter 230, the third modulator 232, and the fourth modulator 234.

The second polarization beamsplitter rotator 242 is configured to rotate the third modulated input light and/or the fourth modulated input light to have different polarizations, combine the third modulated input light and the fourth modulated input light into a second transmit light, and provide the second transmit light into the second transmission link 248 through the third port 241c of the second polarization beamsplitter rotator 242.

Although described as a polarization beamsplitter rotator, the second polarization beamsplitter rotator 242, in some implementations, can be a polarization beamsplitter e.g., without including a rotation functionality.

The second optical transceiver 204 is configured to perform both dual-polarization transmission and reception, such that the second optical transceiver 204 can be configured as a DP-BiDi transceiver. A received optical signal having the first wavelength can be received through the second transmission link 248 at the third port 241c of the second polarization beamsplitter rotator 242. The first wavelength can be, for example, 1271 nm, but is not limited thereto. The third port 241c of the second polarization beamsplitter rotator 242 can be configured to split the received optical signal into components having different (e.g., orthogonal) polarizations. However, the two polarization modes may become mixed among each other due to unpredictable rotations and cross-talk, e.g., in the second transmission link 248. Therefore, the received optical signal can include a third received signal and a fourth received signal having the third and fourth polarization, respectively, where the third and fourth received signals are each a mixture of the third modulated received signal and the fourth modulated received signal.

The third optical element 244 performs wavelength-selective demultiplexing/wavelength separation and provides the third received signal to the second polarization demultiplexer 240 through the second port 243b of the third optical element 244, based on the third received signal having the first wavelength. Similarly, the fourth optical element 246 performs wavelength-selective demultiplexing/wavelength separation and provides the fourth received signal to the second polarization demultiplexer 240 through the second port 245b of the fourth optical element 246, based on the fourth received signal having the first wavelength.

The second polarization demultiplexer 240 can be a 2×2 polarization demultiplexer. The second polarization demultiplexer 240 can be configured to operate on the third and fourth received signals to recover and separately provide, through two respective outputs, the third modulated received signal and the fourth modulated received signal.

Based on operation of the second polarization demultiplexer 240, the third photodetector 236 receives the third modulated received signal (carrying seventh data) and the fourth photodetector 238 receives the fourth modulated received signal (carrying eight data). The photodetectors 236, 238 can output respective electrical signals indicative of the seventh data and eight data, respectively. The photodetectors 236, 238 can detect intensities of received light.

In some implementations, a receiving unit is configured to receive the third optical signal and the fourth optical signal, performing polarization-demultiplexing on the third optical signal and the fourth optical signal to output two polarization-demultiplexed optical signals, and detect intensities of the two polarization-demultiplexed optical signals. For example, a receiving unit can include the second polarization demultiplexer 240, the third photodetector 236, and the fourth photodetector 238.

In some implementations, the electrical signals output by the photodetectors 236, 238 can be further processed. For example, the second optical transceiver 204 can include an electrical demultiplexer configured to receive the electrical signals and perform further demultiplexing to recover the seventh data and the eighth data with less loss. In some implementations, the second optical transceiver 204 includes transimpedance amplifiers (TIA) configured to amplify the electrical signals.

In some implementations, the second optical transceiver 204 includes a second electrical module 247. The electrical signals from the photodetectors 236, 238 are optionally provided into a third transimpedance amplifier 237 and a fourth transimpedance amplifier 239 that produce amplified versions of the signals from the photodetectors. The second electrical module 247 may contain a second electrical demultiplexer 249. The second electrical demultiplexer 249 is configured to perform demultiplexing on electrical signals received from the third and fourth photodetectors 236, 238. In some implementations, a receiving unit can include the second polarization demultiplexer 240, the third photodetector 236, the fourth photodetector 238, and the electrical module 247.

As a result of the operation described above, the second optical transceiver 204 is configured to transmit dual-polarization signals at the second wavelength and to receive dual-polarization signals at the first wavelength, advantageously providing DP-BiDi functionality.

Further, some configurations of the second optical transceiver 204 can provide specific advantages beyond the DP-BiDi functionality. First, the third and fourth optical elements 244, 246 (e.g., wavelength-selective multiplexers/demultiplexers) can be configured to operate on both transmitted (outbound) signals and received (inbound) signals, thereby providing dual, combined functionality that makes efficient use of components and space (e.g., in the context of a SiPh configuration). Similarly, the second polarization beamsplitter rotator 242 is also used for both transmission and reception. Thus, the configuration shown in FIG. 2A can provide a lower cost and/or improved spatial efficiency compared to configurations that have less use of the same component(s) for both transmission and reception.

Further, the configuration shown in FIG. 2A can exhibit reduced loss and/or improved signal processing quality. For example, the second optical transceiver 204 can exhibit high resilience to crosstalk and leakage between signals of the first and second wavelength. For example, even if a signal received through the second transmission link 248 includes components having the second wavelength, those components are substantially or entirely separated by the third and fourth optical elements 244, 246 and are provided to the modulators 232, 234 (e.g., rather than being photodetected), where the components have little or no effect on operation of the second optical transceiver 204.

In some implementations, the optical transceiver 200 can be connected to an additional optical transceiver. It will be understood that an additional optical transceiver is not required and can be omitted or altered without departing from the scope of this disclosure.

In some implementations, FIG. 2B illustrates a transceiver 200a including the first optical transceiver 202 and the second optical transceiver 204 of FIG. 2A and an additional optical transceiver 200b including the first optical transceiver 202 and the second optical transceiver 204 of FIG. 2A. For example, the transceiver 200a can be included in a first device (e.g., a server, a switch, an artificial intelligence (AI) processor, a storage device, a controller, etc.), and the additional optical transceiver 200b can be included in a second device, such that the configuration of FIG. 2B facilitates communication between the first and second devices.

As shown in FIG. 2B, the first optical transceiver 202 of the transceiver 200a is connected to the second optical transceiver 204 of the additional transceiver 200b, such that the first optical transceiver 202 and the second optical transceiver 204 are configured to send out dual-polarization signals at the first wavelength and receive dual-polarization signals at the second wavelength. The second optical transceiver 204 of the transceiver 200a is connected to the first optical transceiver 202 of the additional transceiver 200b, such that the second optical transceiver 204 and the first optical transceiver 202 are configured to send out dual-polarization signals at the second wavelength and receive dual-polarization signals at the first wavelength.

For example, the optical transceiver 200a and the additional optical transceiver 200b can be configured such that the polarization beamsplitter rotator of the first optical transceiver 202 of the transceiver 200a is configured to send out dual-polarization signals at 1310 nm and receive dual-polarization signals at 1271 nm, while the polarization beamsplitter rotator of the second optical transceiver 204 of the additional transceiver 200b is configured to send out dual-polarization signals at 1271 nm and receive dual-polarization signals at 1310 nm. The transmitting and receiving of the dual-polarization signals can occur simultaneously in both directions.

The optical transceivers of FIGS. 2A and 2B can be implemented in silicon photonics (SiPh), e.g., on a silicon substrate, using silicon waveguides and/or other optical elements, and/or the like. Dual-polarization and dual-polarization-bidirectional optics can each be a single-chip silicon-photonic integrated circuit (PIC), containing both the transmitter and receiver (e.g., the first optical transceiver 202). The symbol rate can be, for example, 106 Gbaud, but is not limited thereto. The PICs can be flip-chipped together with a digital-signal processor (DSP) and placed in a suitable module. The transmitter can use internal drivers of the DSP. The system can include electrical circuitry configured to perform signal processing and/or control operations. For example, the circuitry can be configured to provide data signals to the modulators 210, 212; to control elements (e.g., phase-shifters) of the polarization demultiplexer 218 to perform polarization demultiplexing; to control elements (e.g., phase-shifters) of the optical elements 222, 224 to perform wavelength-selective multiplexing/demultiplexing (e.g., based on output of the photodiode 306); to perform electrical demultiplexing on electrical signals output by the photodetectors 214, 216; and/or the like. The system can include an external transimpedance amplifier (TIA), also flip-chipped, to amplify the high-speed photo-detected signals. The systems described herein can be arranged on a common or single substrate as optical integrated circuits. The systems described herein can be implemented as Octal Small Form-factor Pluggable (OSFP) systems. It will be understood that further electrical and/or optical components can be included in the systems shown herein without departing from the scope of this disclosure.

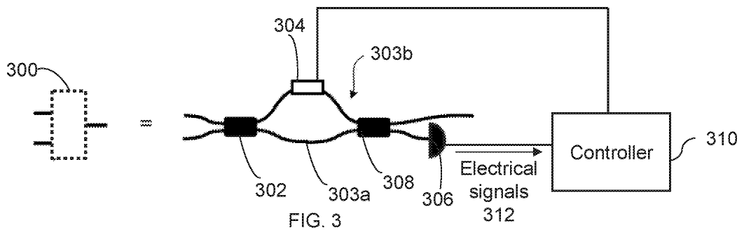

FIG. 3 illustrates an example of an optical element 300 (e.g., optical elements suitable for use in the transceivers of FIGS. 1-2). The optical element 300 is an example of the optical elements 222, 224, 244, and 246 of FIG. 2A. The optical element 300 is a wavelength selective multiplexer/demultiplexer. The multiplexer/demultiplexer can be used for both transmission and reception of optical signals. The multiplexer/demultiplexer can be a wavelength multiplexer/demultiplexer using a Mach-Zehnder interferometer having different lengths. For example, as shown in FIG. 3, a first arm 303a of the Mach-Zehnder interferometer is longer than a second arm 303b of the Mach-Zehnder interferometer. Two optical inputs are provided through a 2×2 coupler 302 which outputs into the two arms 303a and 303b of the Mach-Zehnder interferometer. Phase shifter(s) 304 can be included on one or both arms and can be controlled using feedback from the illustrated photodiode 306, which receives light from one output of a 2×2 coupler 308 at the output of the interferometer. For example, control of the phase shifter(s) 304 (e.g., an amount of the phase shift) can be performed so as to reduce or minimize detected power at the photodiode 306. A controller 310 can be configured to receive electrical signals 312 from the photodiode 306 and adjust the phase shifter(s) 304 to reduce or minimize the detected power. Through this adjustment, the optical element 300 is configured to perform 2×1 wavelength-selective multiplexing/demultiplexing. Thus, the optical element 300 provides relatively simple, inexpensive, spatially-efficient, and low-loss wavelength splitting/combining functionality. In some implementations, the Mach-Zehnder interferometer can have a free-spectral range of two times the channel spacing.

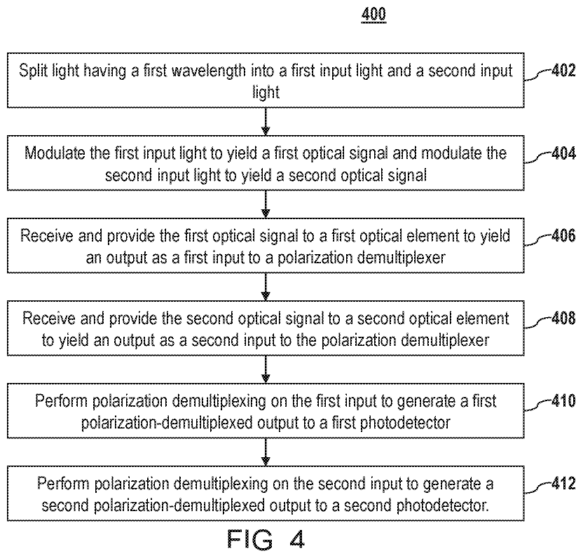

FIG. 4 is a flow chart showing examples of operations 400 of sending and receiving dual-polarization signals. In 402, light having a first wavelength is split into a first input light and a second input light. In 404, the first input light is modulated to yield a first optical signal and the second input light is modulated to yield a second optical signal.

In 406, the first optical signal is received and provided to a first optical element to yield an output as a first input to a polarization demultiplexer. Receiving and providing the first optical signal to the first optical element to yield the output as the first input can include: receiving and providing the first optical signal from a first modulator to the first optical element through a first port of the first optical element, receiving and providing the first optical signal from the first optical element to a polarization beamsplitter rotator through a second port of the first optical element, and receiving and providing the first optical signal from the polarization beamsplitter rotator to a polarization demultiplexer through a third port of the first optical element.

In 408, the second optical signal is received and provided to a second optical element to yield an output as a second input to the polarization demultiplexer. Receiving and providing the second optical signal to the second optical element to yield the output as the second input can include: receiving and providing the second optical signal from a second modulator to the second optical element through a first port of the second optical element, receiving and providing the second optical signal from the second optical element to a polarization beamsplitter rotator through a second port of the second optical element, and receiving and providing the second optical signal from the polarization beamsplitter rotator to a polarization demultiplexer through a third port of the second optical element.

In 410, polarization demultiplexing is performed on the first input to generate a first polarization-demultiplexed output to a first photodetector. In 412, polarization demultiplexing is performed on the second input to generate a second polarization-demultiplexed output to a second photodetector.

### EXAMPLES

The scope of the present disclosure includes at least the following examples and methods.

Aspect 1: An optical transceiver includes: a light source configured to output light having a first wavelength, a first modulator, a second modulator, a first photodetector, a second photodetector, a 2×2 multi-input-multi-output (MIMO) demultiplexer, a polarization beamsplitter, a first optical multiplexer/demultiplexer, wherein the first optical multiplexer/demultiplexer is wavelength selective between the first wavelength and a second wavelength different from the first wavelength, and a second optical multiplexer/demultiplexer, wherein the second optical multiplexer/demultiplexer is wavelength selective between the first wavelength and the second wavelength. The first modulator is connected between the light source and the first optical multiplexer/demultiplexer, the second modulator is connected between the light source and the second optical multiplexer/demultiplexer, the 2×2 MIMO demultiplexer is connected between the first and second optical multiplexer/demultiplexers and the first and second photodetectors, and the first and second optical multiplexer/demultiplexers are connected to the polarization beamsplitter.

Aspect 2: Aspect 1, including: a splitter configured to split the light from the light source into a first input light and a second input light.

Aspect 3: Aspect 2, in which the first modulator is configured to modulate the first input light from the light source to output a first optical signal and the second modulator is configured to modulate the second input light from the light source to output a second optical signal.

Aspect 4: Any one of the foregoing aspects, in which the polarization beamsplitter includes a polarization beamsplitter rotator.

Aspect 5: Any one of the foregoing aspects, in which the polarization beamsplitter rotator is configured to: perform polarization rotation to cause a first modulated optical signal from the first optical multiplexer/demultiplexer and a second modulated optical signal from the second optical multiplexer/demultiplexer to have different polarizations, combine the first modulated optical signal and the second modulated optical signal into transmit light, provide the transmit light to a transmission link, and receive light from the transmission link.

Aspect 6: Any one of the foregoing aspects, in which the first optical multiplexer/demultiplexer includes: a first port configured to receive a first optical signal from the first modulator, a second port configured to provide an output as a first optical input to the 2×2 MIMO demultiplexer, and a third port configured to provide optical signals to a first port of the polarization beamsplitter and receive optical signals from the first port of the polarization beamsplitter. The first optical multiplexer/demultiplexer is configured to: combine optical signals from the first and second ports of the first optical multiplexer/demultiplexer to output a combined optical signal at the third port of the first optical multiplexer/demultiplexer, and wavelength-separate the optical signals received at the third port of the first optical multiplexer/demultiplexer into a first component, having the first wavelength, that is provided to the first port of the first optical multiplexer/demultiplexer, and a second component, having a second wavelength, that is provided to the second port of the first optical multiplexer/demultiplexer.

Aspect 7: Any one of the foregoing aspects, in which the first optical multiplexer/demultiplexer includes: a Mach-Zehnder interferometer, a first 2×2 coupler connected between the first and second ports and two arms of the Mach-Zehnder interferometer, a second 2×2 coupler connected between the two arms of the Mach-Zehnder interferometer and a photodetector, and at least one phase-shifter on at least one of the two arms of the Mach-Zehnder interferometer, wherein the at least one phase-shifter is adjusted based on optical power detected by the photodetector.

Aspect 8: Any one of the foregoing aspects, in which the two arms of the Mach-Zehnder interferometer have different lengths.

Aspect 9: Any one of the foregoing aspects, in which the second 2×2 coupler is connected between the two arms of the Mach-Zehnder interferometer and a port of the first optical multiplexer/demultiplexer that is connected to the polarization beamsplitter.

Aspect 10: Any one of the foregoing aspects, in which the optical transceiver includes a transimpedance amplifier configured to receive and amplify a first electrical signal from the first photodetector.

Aspect 11: Any one of the foregoing aspects, in which the optical transceiver includes an electrical 2×2 MIMO demultiplexer configured to perform 2×2 MIMO demultiplexing on electrical signals received from the first and second photodetectors.

Aspect 12: Any one of the foregoing aspects, in which a second light source, a third modulator, a fourth modulator, a third photodetector, a fourth photodetector, a second 2×2 MIMO demultiplexer configured to provide two outputs to the third photodetector and the fourth photodetector, respectively, a second polarization beamsplitter, a third optical multiplexer/demultiplexer, wherein the third optical multiplexer/demultiplexer is wavelength selective, and a fourth optical multiplexer/demultiplexer, wherein the fourth optical multiplexer/demultiplexer is wavelength selective. The third modulator is connected between the second light source and the third optical multiplexer/demultiplexer, the fourth modulator is connected between the second light source and the fourth optical multiplexer/demultiplexer, the second 2×2 MIMO demultiplexer is connected between the third and fourth optical multiplexer/demultiplexers and the third and fourth photodetectors, and the third and fourth optical multiplexer/demultiplexers are connected to the second polarization beamsplitter.

Aspect 13: Any one for the foregoing aspects, in which the optical transceiver is integrated on a single chip.

Aspect 14: Any of the foregoing aspects, in which the optical transceiver includes a silicon photonics chip.

Method 15: A method of sending and receiving dual-polarization signals that includes: splitting light having a first wavelength into a first input light and a second input light, modulating the first input light to yield a first optical signal and modulating the second input light to yield a second optical signal, receiving and providing the first optical signal to a first optical element to yield an output as a first input to a 2×2 MIMO demultiplexer, receiving and providing the second optical signal to a second optical element to yield an output as a second input to the 2×2 MIMO demultiplexer, performing 2×2 MIMO demultiplexing on the first input to generate a first 2×2 MIMO demultiplexed output to a first photodetector, and performing 2×2 MIMO demultiplexing on the second input to generate a second 2×2 MIMO demultiplexed output to a second photodetector.

Method 16: Method 15, in which the first and second optical elements include wavelength selective optical elements.

Method 17: Methods 15 or 16, in which the receiving and providing the first optical signal to the first optical element to yield the output as the first input includes: receiving and providing the first optical signal from a first modulator to the first optical element through a first port of the first optical element, receiving and providing the first optical signal from the first optical element to a polarization beamsplitter rotator through a second port of the first optical element, and receiving and providing the first optical signal from the polarization beamsplitter rotator to a 2×2 MIMO demultiplexer through a third port of the first optical element.

Method 18: Methods 15-17, in which receiving and providing the second optical signal to the second optical element to yield the output as the second input includes: receiving and providing the second optical signal from a second modulator to the second optical element through a first port of the second optical element, receiving and providing the second optical signal from the second optical element to a polarization beamsplitter rotator through a second port of the second optical element, and receiving and providing the second optical signal from the polarization beamsplitter rotator to a 2×2 MIMO demultiplexer through a third port of the second optical element.

Aspect 19: An optical transceiver includes: a light source configured to output light having a first wavelength, a transmission unit configured to output a first modulated input signal and a second modulated input signal, a polarization beamsplitter rotator configured to cause the first modulated input signal and the second modulated input signal to have different polarizations, a first optical element configured to (i) receive the first modulated input signal from the transmission unit, (ii) provide and receive optical signals to and from the polarization beamsplitter rotator, and (iii) provide a first optical signal from the polarization beamsplitter rotator to a receiving unit, wherein the first optical element is wavelength selective, a second optical element configured to (i) receive the second modulated input signal from the transmission unit, (ii) provide and receive optical signals to and from the polarization beamsplitter rotator, and (iii) provide a second optical signal from the polarization beamsplitter rotator to the receiving unit, wherein the second optical element is wavelength selective, and the receiving unit. The receiving unit is configured to (i) receive the first optical signal and the second optical signal, (ii) perform polarization-demultiplexing on the first optical signal and the second optical signal to output two polarization-demultiplexed optical signals, and (iii) detect intensities of the two polarization-demultiplexed optical signals.

Aspect 20: Aspect 19, in which optical transceiver is integrated on a single chip.

Aspect 21: Aspects 19 and 20, in which the first and second optical elements include: a Mach-Zehnder interferometer, a first 2×2 coupler connected between the transmission unit and two arms of the Mach-Zehnder interferometer, a second 2×2 coupler connected between the two arms of the Mach-Zehnder interferometer and a photodetector, and at least one phase-shifter on at least one of the two arms of the Mach-Zehnder interferometer, wherein the at least one phase-shifter is adjusted based on optical power detected by the photodetector.

Aspect 22: An optical transceiver includes: an input/output port, wherein the optical transceiver is configured to transmit a first dual-polarization optical signal having a first wavelength at the input/output port, and wherein the optical transceiver is configured to receive a second dual-polarization optical signal having a second wavelength at the input/output port, wherein the first wavelength is different from the second wavelength.

Aspect 23: Aspect 22, including: a transmission unit configured to output a first modulated input signal and a second modulated input signal carrying first data and second data, respectively, wherein the first modulated input signal and the second modulated input signal have the first wavelength, and wherein the first dual-polarization optical signal is based on the first modulated input signal and the second modulated input signal, and a receiving unit configured to receive a first optical signal and a second optical signal and detect a first data signal and a second data signal based on 2×2 MIMO demultiplexing, wherein the first optical signal and the second optical signal have the second wavelength, and wherein the first optical signal and the second optical signal are based on the second dual-polarization optical signal.

Aspect 24: Aspects 22 or 23, including: a wavelength-selective multiplexer/demultiplexer configured to operate on light from the first dual-polarization optical signal and on light from the second dual-polarization optical signal.

Aspect 25: Aspects 22-24, in which the first dual-polarization optical signal and the second dual-polarization optical signal are dual-polarization intensity-modulated direct-detect signals.

The examples of architectures of systems described herein are not exhaustive. For example, additional optical and/or electrical components can be included in the transmitters and receivers described herein without departing from the scope of this disclosure, such as optical and/or electrical filters, amplifiers/attenuators, splitters, couplers, etc. Moreover, in some implementations, one or more optical and/or electrical component shown in the described transmitters and receivers can be omitted, without departing from the scope of this disclosure. In addition, unless otherwise indicated, signals and light described as being “from” a component need not be directly from the component but, rather, can have been processed in one or more ways.

While this disclosure contains many specific implementation details, these should not be construed as limitations on the scope of any invention or of what may be claimed, but rather as descriptions of features that may be specific to particular implementations of particular inventions. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

What is claimed is:

1. An optical transceiver comprising:
a light source configured to output light having a first wavelength;
a first modulator;
a second modulator;
a first photodetector;
a second photodetector;
a 2×2 multi-input-multi-output (MIMO) demultiplexer;
a polarization beamsplitter;
a first optical multiplexer/demultiplexer, wherein the first optical multiplexer/demultiplexer is wavelength selective between the first wavelength and a second wavelength different from the first wavelength; and
a second optical multiplexer/demultiplexer, wherein the second optical multiplexer/demultiplexer is wavelength selective between the first wavelength and the second wavelength,
wherein the first modulator is connected between the light source and the first optical multiplexer/demultiplexer,
wherein the second modulator is connected between the light source and the second optical multiplexer/demultiplexer,
wherein the 2×2 MIMO demultiplexer is connected between the first and second optical multiplexer/demultiplexers and the first and second photodetectors, and
wherein the first and second optical multiplexer/demultiplexers are connected to the polarization beamsplitter.

2. The optical transceiver of claim 1, wherein the optical transceiver comprises a splitter configured to split the light from the light source into a first input light and a second input light.

3. The optical transceiver of claim 2, wherein:
the first modulator is configured to modulate the first input light from the light source to output a first optical signal; and
the second modulator is configured to modulate the second input light from the light source to output a second optical signal.

4. The optical transceiver of claim 1, wherein the polarization beamsplitter comprises a polarization beamsplitter rotator.

5. The optical transceiver of claim 4, wherein the polarization beamsplitter rotator is configured to:
perform polarization rotation to cause a first modulated optical signal from the first optical multiplexer/demultiplexer and a second modulated optical signal from the second optical multiplexer/demultiplexer to have different polarizations,
combine the first modulated optical signal and the second modulated optical signal into transmit light,
provide the transmit light to a transmission link, and
receive light from the transmission link.

6. The optical transceiver of claim 1, wherein the first optical multiplexer/demultiplexer comprises:
a first port configured to receive a first optical signal from the first modulator,
a second port configured to provide an output as a first optical input to the 2×2 MIMO demultiplexer, and
a third port configured to provide optical signals to a first port of the polarization beamsplitter and receive optical signals from the first port of the polarization beamsplitter,
wherein the first optical multiplexer/demultiplexer is configured to:
combine optical signals from the first and second ports of the first optical multiplexer/demultiplexer to output a combined optical signal at the third port of the first optical multiplexer/demultiplexer, and
wavelength-separate the optical signals received at the third port of the first optical multiplexer/demultiplexer into a first component, having the first wavelength, that is provided to the first port of the first optical multiplexer/demultiplexer, and a second component, having a second wavelength, that is provided to the second port of the first optical multiplexer/demultiplexer.

7. The optical transceiver of claim 1, wherein the first optical multiplexer/demultiplexer comprises:
a Mach-Zehnder interferometer;
a first 2×2 coupler connected between the first and second ports and two arms of the Mach-Zehnder interferometer;
a second 2×2 coupler connected between the two arms of the Mach-Zehnder interferometer and a photodetector; and
at least one phase-shifter on at least one of the two arms of the Mach-Zehnder interferometer, wherein the at least one phase-shifter is adjusted based on optical power detected by the photodetector.

8. The optical transceiver of claim 7, wherein the two arms of the Mach-Zehnder interferometer have different lengths.

9. The optical transceiver of claim 7, wherein the second 2×2 coupler is connected between the two arms of the Mach-Zehnder interferometer and a port of the first optical multiplexer/demultiplexer that is connected to the polarization beamsplitter.

10. The optical transceiver of claim 1, wherein the optical transceiver comprises a transimpedance amplifier configured to receive and amplify a first electrical signal from the first photodetector.

11. The optical transceiver of claim 1, wherein the optical transceiver comprises an electrical 2×2 MIMO demultiplexer configured to perform 2×2 MIMO demultiplexing on electrical signals received from the first and second photodetectors.

12. The optical transceiver of claim 1, comprising:
a second light source;
a third modulator;
a fourth modulator;
a third photodetector;
a fourth photodetector;
a second 2×2 MIMO demultiplexer configured to provide two outputs to the third photodetector and the fourth photodetector, respectively;
a second polarization beamsplitter;
a third optical multiplexer/demultiplexer, wherein the third optical multiplexer/demultiplexer is wavelength selective; and
a fourth optical multiplexer/demultiplexer, wherein the fourth optical multiplexer/demultiplexer is wavelength selective,
wherein the third modulator is connected between the second light source and the third optical multiplexer/demultiplexer,
wherein the fourth modulator is connected between the second light source and the fourth optical multiplexer/demultiplexer,
wherein the second 2×2 MIMO demultiplexer is connected between the third and fourth optical multiplexer/demultiplexers and the third and fourth photodetectors, and
wherein the third and fourth optical multiplexer/demultiplexers are connected to the second polarization beamsplitter.

13. The optical transceiver of claim 12, wherein the optical transceiver is integrated on a single chip.

14. The optical transceiver of claim 1, wherein the optical transceiver comprises a silicon photonics chip.

15. An optical transceiver comprising:
a light source configured to output light having a first wavelength;
a transmission unit configured to output a first modulated input signal and a second modulated input signal;
a polarization beamsplitter rotator configured to cause the first modulated input signal and the second modulated input signal to have different polarizations;
a first optical element configured to (i) receive the first modulated input signal from the transmission unit, (ii) provide and receive optical signals to and from the polarization beamsplitter rotator, and (iii) provide a first optical signal from the polarization beamsplitter rotator to a receiving unit, wherein the first optical element is wavelength selective;
a second optical element configured to (i) receive the second modulated input signal from the transmission unit, (ii) provide and receive optical signals to and from the polarization beamsplitter rotator, and (iii) provide a second optical signal from the polarization beamsplitter rotator to the receiving unit, wherein the second optical element is wavelength selective; and
the receiving unit, wherein the receiving unit is configured to (i) receive the first optical signal and the second optical signal, (ii) perform polarization-demultiplexing on the first optical signal and the second optical signal to output two polarization-demultiplexed optical signals, and (iii) detect intensities of the two polarization-demultiplexed optical signals.

16. The optical transceiver of claim 15, wherein the first and second optical elements comprise:
a Mach-Zehnder interferometer;
a first 2×2 coupler connected between the transmission unit and two arms of the Mach-Zehnder interferometer;
a second 2×2 coupler connected between the two arms of the Mach-Zehnder interferometer and a photodetector; and
at least one phase-shifter on at least one of the two arms of the Mach-Zehnder interferometer, wherein the at least one phase-shifter is adjusted based on optical power detected by the photodetector.

17. An optical transceiver comprising:
an input/output port,
wherein the optical transceiver is configured to transmit a first dual-polarization optical signal having a first wavelength at the input/output port, and
wherein the optical transceiver is configured to receive a second dual-polarization optical signal having a second wavelength at the input/output port, wherein the first wavelength is different from the second wavelength.

18. The optical transceiver of claim 17, comprising:
a transmission unit configured to output a first modulated input signal and a second modulated input signal carrying first data and second data, respectively, wherein the first modulated input signal and the second modulated input signal have the first wavelength, and wherein the first dual-polarization optical signal is based on the first modulated input signal and the second modulated input signal; and
a receiving unit configured to receive a first optical signal and a second optical signal and detect a first data signal and a second data signal based on 2×2 MIMO demultiplexing, wherein the first optical signal and the second optical signal have the second wavelength, and wherein the first optical signal and the second optical signal are based on the second dual-polarization optical signal.

19. The optical transceiver of claim 17, comprising a wavelength-selective multiplexer/demultiplexer configured to operate on light from the first dual-polarization optical signal and on light from the second dual-polarization optical signal.

20. The optical transceiver of claim 17, wherein the first dual-polarization optical signal and the second dual-polarization optical signal are dual-polarization intensity-modulated direct-detect signals.
